(19) United States
(12) Patent Application Publication
(10) Pub. No.: US 2015/0114854 A1
(43) Pub. Date: Apr. 30, 2015

(54) PILL CONTAINMENT DEVICE

(71) Applicant: Anne Jenks, Prairie Du Chien, WI (US)

(72) Inventor: Anne Jenks, Prairie Du Chien, WI (US)

(21) Appl. No.: 14/061,869

(22) Filed: Oct. 24, 2013

(51) Int. Cl. A61J 1/03

(52) U.S. Cl. CPC A61J 1/03; A61J 2200/00
USPC 206/204; 206/538; 206/1.5

(57) ABSTRACT

A pill containment device comprising a housing, where the housing includes an inner cavity to receive a plurality of pills; a lid attached to an edge of the housing, where the lid covers the inner cavity; a secure combination locking system on the lid, where the secure combination locking system fastens the lid to the housing; and a plurality of pellets within the inner cavity of the housing, where the plurality of pellets wick moisture from the plurality of pills. The pill containment device may store the pills until a user disposes of the pills at a proper waste facility.

### BACKGROUND OF THE INVENTION

1. Field of the Invention

The present invention relates to a device to dispose of prescription pills, where the pills are placed in a lockable container for storage and then disposal.

2. Description of Related Art

Many people have a medicine cabinet filled with various necessary and unnecessary bathroom items. Typically, the cabinets include items like medication bottles, toothbrushes and toothpaste, lotions, sanitary needs, makeup, first-aid items, and the like. The people want their medications easily available while in the bathroom, especially bottles filled with pills/capsules for ailments, prescriptions and vitamins. Over time a person may accumulate a lot of old and forgotten items. Expired prescribed medications often sit in the cabinet for months even years after their expiration dates.

There are specific guidelines outlined by the Food and Drug Administration (FDA) on how to properly dispose of the medications (www.fda.gov). Some items may be thrown in trash while others should be flushed down the toilet. There are “take-back” centers where a person may drop-off their prescription medications and have them disposed of properly. If the person is unsure about what to do with the medications, the FDA advises that they take the pills out of the bottles and mix them with undesirable substances like coffee or kitty litter—to make the pills less appealing or recognizable. Then the user may dispose of the medications in a sealable container and finally throw them in the trash.

Even with these precautions, children, pets and other adults may ingest these medications if they are not stored properly. This may be very dangerous because of overdose and medication mixing. Therefore it would be beneficial in the art to provide a container that locks away unwanted and expired medications. It would also be desirable in the art to provide a disposal container that includes a means to hide or disguise the pills before disposal.

### SUMMARY OF THE INVENTION

In view of the foregoing disadvantages inherent in the prior art, the general purpose of the present invention is to provide a pill containment device to dispose of medications, configured to include all of the advantages of the prior art, and to overcome the drawbacks inherent therein.

Accordingly, an object of the present invention is to provide a container that stores prescription drugs to keep them away from people and pets until disposed of properly.

Another object of the present invention is to provide a container for medications that includes pellets to wick moisture and to disguise the pills.

To achieve the above objects, in an aspect of the present invention, a pill containment device is described comprising a housing, where the housing includes an inner cavity to receive a plurality of pills; a lid attached to an edge of the housing, where the lid covers the inner cavity; a secure combination locking system on the lid, where the secure combination locking system fastens the lid to the housing; and a plurality of pellets within the inner cavity of the housing, where the plurality of pellets wick moisture from the plurality of pills. The pill containment device may store the pills until a user disposes of the pills at a proper waste facility.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a pill containment device in accordance with an exemplary embodiment of the present invention.

### DETAILED DESCRIPTION OF THE DRAWINGS

The present invention relates to a device to dispose of prescription pills, where the pills are placed in a lockable container for storage and then disposal. The invention provides a pill containment device as an inexpensive system that allows a user to store and dispose of unused or expired medicines safely. The pill containment device includes a container and lid, where the lid incorporates a secure combination locking mechanism. The secure combination locking mechanism prevents both children and adults from accessing the inner contents of the container. By locking the container the medication stored within the container are kept away from those individuals who should not be taking the drugs.

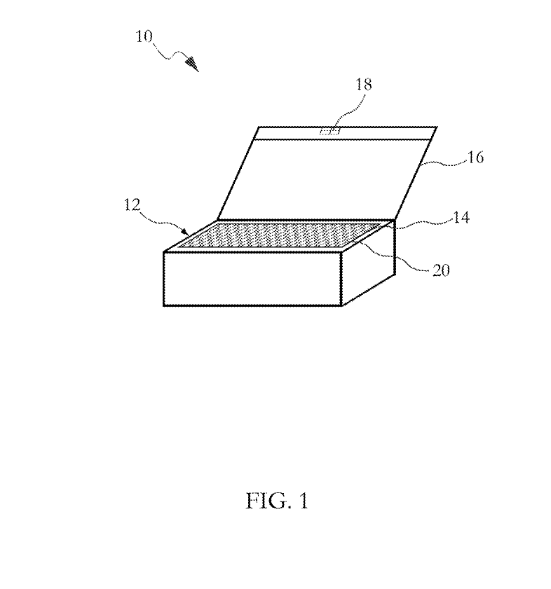

Turning now descriptively to the drawings, referring to FIG. 1, a perspective view of a pill containment device 10 is shown in accordance with an exemplary embodiment of the present invention. The pill containment device 10 includes a housing 12, where the housing 12 includes an inner cavity 14. The housing 12 may be shaped as a box or cylinder for a simple and discrete design. The inner cavity 14 receives a plurality of pills. Typically, expired, unwanted and unnecessary medications or pills are placed within the housing 12 that will later be disposed of at the user's convenience. On an outer face of the housing 12 the word “WASTE” may be printed to deter others from tampering with the pill containment device 10. The housing 12 may be made from plastic, aluminum or steel, to ensure that tampering is difficult or that the housing 12 is impossible to break.

Attached to an edge of the housing 12 is a lid 16. The lid 16 may be attached on a hinge to withstand repeated opening and closing of the lid 16 over the inner cavity 14. The lid 16 includes a secure locking system 18 to fasten the lid 16 to the housing 12. The secure locking system 18 includes a keypad or multiple combination lock dials, where the user enters a specific code in order to release the secure locking system 18 and to open the lid 16. Alternatively, the secure locking system 18 may be a lock with a key so that the user does not have to remember a code for opening. The secure locking system 18 enables the housing 12 to remain locked for storage until the user is able to dispose of the inner contents of the pill containment device 10.

Within the inner cavity 14 may be a plurality of pellets 20. The pellets 20 may be made from clay or silicone in order to wick moisture away from one or more pills that are placed inside the housing 12. The pellets 20 may resemble a gel capsule pill or a pressed pill, this way the real medication is camouflaged with the surrounding pellets 20. By camouflaging the pills those who may open the housing 12 will not know which items are the pills or the pellets therefore they will be deterred from ingesting any of the inner contents.

To use the pill containment device the user unlocks the secure locking system to open the lid from the housing. Next, they place one or more pills into the inner cavity of the housing. The pills are camouflaged by the surrounding pill shaped pellets. The user may then lock the secure locking system to refasten the lid against the housing. Finally, the user may store the pill containment device in a safe location or they may dispose of the pill containment device at a proper waste facility. The pill containment device provides a safe and secure location for a user to store their used or unwanted medications. This way children, animals and adults are unable to ingest the pills.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A pill containment device comprising:
a. a housing, where the housing includes an inner cavity to receive a plurality of pills;
b. a lid attached to an edge of the housing, where the lid covers the inner cavity;
c. a secure locking system on the lid, where the secure locking system fastens the lid to the housing; and
d. a plurality of pellets within the inner cavity of the housing, where the plurality of pellets wick moisture from the plurality of pills.

2. The pill containment device according to claim 1, where the plurality of pellets are shaped to resemble the plurality of pill, where the plurality of pill shaped pellets camouflage the plurality of pills.

3. The pill containment device according to claim 1, where the secure locking system includes a keypad.

4. The pill containment device according to claim 1, where the secure locking system includes a plurality of combination lock dials.

5. The pill containment device according to claim 1, where the secure locking system includes a lock and key.

6. A method of use for a pill containment device comprising the steps of:
a. unlocking a secure locking system on the pill containment device, where the secure locking system fastens a housing to a lid of the pill containment device;
b. placing at least one pill into an inner cavity of the housing, where the inner cavity includes a plurality of pill shaped pellets to camouflage the pill; and
c. locking the secure locking system to refasten the lid against the housing.

7. The method of use for a pill containment device according to claim 6 further including the step of storing the pill containment device.

8. The method of use for a pill containment device according to claim 6 further including the step of disposing of the pill containment device at a proper waste facility.
